(19) United States
(12) Patent Application Publication
(10) Pub. No.: US 2015/0167620 A1
(43) Pub. Date: Jun. 18, 2015

(54) MOTOR VEHICLE ENGINE AND METHOD FOR STARTING A MOTOR VEHICLE

(71) Applicant: Schaeffler Technologies GmbH & Co. KG, Herzogenaurach (DE)

(72) Inventors: Wolfgang Haas, Buehl (DE); Oswald Friedmann, Lichtenau (DE)

(73) Assignee: Schaeffler Technologies GmbH & Co. KG, Herzogenaurach (DE)

(21) Appl. No.: 14/406,900

(22) PCT Filed: Jun. 5, 2013
(86) PCT No.: PCT/EP13/61537

§ 371 Date: Dec. 10, 2014

(30) Foreign Application Priority Data
Jun. 20, 2012 (DE) 102012210428.3

(51) Int. Cl. F02N 15/08; F02N 11/04; F01L 1/02; F02N 11/08; F02N 11/00; F16F 15/20

(52) U.S. Cl. CPC F02N 15/08; F02N 11/003; F16F 15/20; F01L 1/02; F02N 11/0803; F02N 11/04

(57) ABSTRACT

An engine for a motor vehicle having an engine housing, a driveshaft for controlling valves of combustion cylinders, the driveshaft driven inside the engine housing, a transmission shaft coupled to the driveshaft and operatively arranged to damp a rotational vibration of the driveshaft, and, a starter coupled to the transmission shaft to direct a start torque into the driveshaft to start the motor vehicle engine. A method for driving a motor vehicle with a motor vehicle engine, the method comprising the steps of providing a starting torque with a starter, directing the starting torque into a driveshaft to start the motor vehicle engine, controlling valves of internal combustion cylinders with the driveshaft, and, damping rotational vibration of the driveshaft with a transmission shaft coupled to the driveshaft, the transmission shaft arranged inside an engine housing of the motor vehicle engine and projecting out of the engine housing.

### CROSS-REFERENCE TO RELATED APPLICATIONS

The present application is the U.S. National Stage application pursuant to 35 U.S.C. §371 of International Application No. PCT/EP2013/061537, filed on Jun. 5, 2013, which application claims the benefit of German Patent Application No. DE 10 2012 210 428.3, filed on Jun. 20, 2012, which applications are incorporated herein by reference in their entireties.

### TECHNICAL FIELD

The present invention relates generally to a motor vehicle engine, and to a method for starting a motor vehicle engine, and, more specifically, to a method for starting a motor vehicle engine in start-stop applications.

### BACKGROUND

A belt drive with a belt pulley for the purpose of driving auxiliary assemblies is known from German Patent No. DE 101 48 961 A1. The belt drive is connected to a crankshaft of an internal combustion engine via a planetary gear, wherein a starter can direct a starting torque via the belt drive to the crankshaft for the purpose of starting the internal combustion engine.

### SUMMARY

According to aspects illustrated herein, there is provided an engine for a motor vehicle having an engine housing, a driveshaft for controlling valves of combustion cylinders, the driveshaft arranged to be driven from inside the engine housing, a transmission shaft coupled to the driveshaft and operatively arranged to damp a rotational vibration of the driveshaft, and, a starter coupled to the transmission shaft to direct a start torque into the driveshaft to start the motor vehicle engine.

According to aspects illustrated herein, there is provided a method for starting a motor vehicle engine, the method including the steps of directing a start torque inside an engine housing of the motor vehicle engine into a driveshaft, and, guiding the driveshaft out of the engine housing.

According to aspects illustrated herein, there is provided a method for driving a motor vehicle having a motor vehicle engine, the method comprising the steps of providing a starting torque with a starter, directing the starting torque into a driveshaft to start the motor vehicle engine, controlling valves of internal combustion cylinders with the driveshaft, and, damping rotational vibration of the driveshaft with a transmission shaft coupled to the driveshaft, the transmission shaft arranged inside an engine housing of the motor vehicle engine and projecting out of the engine housing.

A general object of the present invention is to provide a motor vehicle engine with a cost-effective design and a construction that saves space.

According to the invention, a use of a transmission shaft—particularly a countershaft for the purpose of damping rotational vibration of the driveshaft, or a camshaft for the purpose of controlling valves of internal combustion cylinders—arranged inside an engine housing of a motor vehicle engine, said transmission shaft coupled to a driveshaft which projects out of an engine housing, for the purpose of driving a motor vehicle, is exploited for the purpose of directing a starting torque which can be provided by a starter—and particularly a starter generator—into the driveshaft for the purpose of starting the motor vehicle engine.

Because the direction of the start torque into the driveshaft occurs inside of the engine housing rather that outside of the engine housing, it is possible inside the engine housing to use the transmission shaft which is, by default, included in the internal combustion engine, for the flow of energy from the starter into the driveshaft, and to exploit the transmission ratio provided by this transmission shaft to make it possible to direct a torque conversion for a start torque, which is higher than a torque generated by the starter, into the driveshaft, without an additional planetary gear arranged outside of the engine housing. By using the transmission shaft which is, by default, included inside the engine housing for the purpose of directing a start torque into the driveshaft, it is possible to dispense with an additional gear, such that the configuration enables a cost-effective design with a construction which saves space, for the purpose of starting the motor vehicle engine, particularly for start-stop applications.

In an example embodiment, the transmission shaft is driven synchronously with the driveshaft. The transmission shaft can, by way of example, be coupled for this purpose to the driveshaft, via a pair of intermeshing gears, a chain drive and/or a belt drive, for the purpose of starting the motor vehicle engine. It is possible to avoid a flow of torque from the starter to the driveshaft via belt drives and/or torque transmission means with a friction-fit connection, and to provide an exclusively positive-fit-based flow of torque from the starter to the driveshaft, such that it is possible to create a transmission ratio for a particularly high start torque.

In an example embodiment, a transmission ratio of i>1.0 is established in the flow of power from the starter—the same designed as a starter generator—to the driveshaft, in order to convert the torque generated by the starter into a higher start torque. This makes it possible to use a comparably small and space-saving electrical machine for the starter, by means of which it is also possible to start internal combustion engines with greater torque power—particularly diesel engines.

By way of example, a countershaft for the purpose of damping vibrations of the 2nd engine order can be a suitable transmission shaft with a transmission ratio of i=2.0. In this case, the countershaft has a countershaft gear which intermeshes with the driveshaft, wherein the torque coming from the starter preferably is directed into the same countershaft gear, from the side which faces away from the driveshaft. The transmission shaft is arranged, at least to a large degree, and preferably entirely, inside the engine housing of the motor vehicle engine. The transmission shaft can optionally have a smaller section which projects from the engine housing for the purpose of connecting to the starter and/or establishing a coupling to the driveshaft via torque transmission means—by way of example a belt drive—configured partially outside of the engine housing.

The starter can be implemented by an electrical machine which can be operated both in a motor operation mode and a generator mode. The starter can be supplied with power by an energy source with is separate from the motor vehicle engine—e.g., a motor vehicle battery—in order to be able to provide sufficient power for the start of the motor vehicle engine when the motor vehicle engine is off. The starter is designed for a plurality of starting processes in brief time intervals, such that the starter can be used efficiently for motor vehicle engines with a start-stop function.

In an example embodiment, the engine housing is designed as a cylinder head, an engine block, a crankcase, and an oil pan. The transmission shaft is arranged inside of the surface of the engine housing which faces outward—at least partially, preferably mostly or entirely. The transmission shaft can preferably be configured inside an oiled chamber of the motor vehicle engine—by way of example inside the crankcase and/or the oil pan.

The transmission shaft can be permanently coupled to the driveshaft with a fixed, permanent transmission ratio of i>1.0. The transmission shaft can particularly not be uncoupled from the driveshaft, thereby enabling a particularly simple construction with no additional actuators. In addition, as a result, the transmission ratio can be a fixed specification such that no sensor system is required for determining the current transmission ratio, nor is an actuator system required for modifying the transmission ratio. As a result of the actuator and sensor systems being dispensed with, the connection of the starter to the driveshaft inside the engine housing can even be made in an oil chamber of the motor vehicle engine, with no additional protective housing. The resulting, substantially rigid coupling of the transmission shaft to the driveshaft does not require any planetary gear, such that the configuration avoids multiple components which can move relative to each other, as in a planetary gear. The starter is able to couple to the driveshaft for the purpose of starting the motor vehicle engine, with no intervening planetary gear.

In an example embodiment, the starter is preferably coupled to the transmission shaft via at least one freewheel and/or at least one coupling. This makes it possible to interrupt the flow of torque between the starter and the driveshaft, after the motor vehicle engine is started. By way of example, the driveshaft can rotate at a minimum frequency after the motor vehicle engine is started, wherein at this frequency the freewheel configured between the starter and the driveshaft goes into override mode, such that the driveshaft is not braked by the starter. A switchable freewheel and/or a switchable clutch is/are preferably included. The clutch can be designed, by way of example, as a friction clutch, particularly a disk clutch or multi-disk clutch, or as a positive-fitting clutch—for example a jaw clutch. As a result, the starter can be used for different operating modes. When a start torque is directed into the driveshaft (“starter mode”) by means of the starter to start the motor vehicle engine, the starter can be coupled to the driveshaft. Once the motor vehicle engine is started, the starter can be operated as a generator with the freewheel locking and/or with the clutch closed, in order to generate storable electrical energy (“generated mode”) by means of the starter, which is designed as a starter generator—wherein said energy can be stored in the motor vehicle battery. In addition, it is possible during the continuing operation of the motor vehicle engine for the starter to direct an additional torque into the driveshaft, in order to be able to provide peak torques which are demanded for brief intervals (“boost mode”), by way of example. In addition, it is possible that the starter can drive an auxiliary assembly—for example an air conditioner compressor—when the starter is uncoupled from the driveshaft, such that an air conditioning system of the motor vehicle can be operated (“parking air conditioning”) when the motor vehicle engine is shut off.

The invention further relates to a motor vehicle engine, such as an internal combustion engine, having an engine housing, a driveshaft which can be driven inside the engine housing, such as a crankshaft, for the purpose of driving a motor vehicle, wherein the driveshaft projects out of the engine housing, a transmission shaft which is arranged inside the engine housing and is coupled to the driveshaft—such as a countershaft for the purpose of damping rotational vibrations of the driveshaft or camshaft used for controlling the combustion cylinders, wherein a starter, such as a starter generator, is coupled to the transmission shaft for the purpose of directing a start torque into the driveshaft for the purpose of starting the motor vehicle engine. The motor vehicle engine can be constructed and implemented as described above in the context of the use of the transmission shaft. It is possible to dispense with an additional gear as a result of the use of the transmission shaft which is already, by default, included inside the engine housing, for the purpose of directing a start torque into the driveshaft, such that the configuration enables a cost-effective design with a construction which saves space, for the purpose of starting the motor vehicle engine, particularly for start-stop applications.

In an example embodiment, the transmission shaft is permanently coupled to the driveshaft with a transmission ratio of i>1.0. The transmission shaft can particularly not be uncoupled from the driveshaft, thereby enabling a particularly simple construction with no additional actuators.

In an example embodiment, the transmission shaft is arranged entirely inside the engine housing. This configuration avoids there being part of the transmission shaft which projects out of the engine housing. In particular, a countershaft used for the purpose of damping rotational vibrations, said countershaft being coupled to the driveshaft, can be used as a suitable transmission shaft, to direct the torque from the starter into the driveshaft. The countershaft can be designed for the purpose of damping vibrations of the 2nd engine order or higher engine orders, such that it is possible to use a transmission ratio of i=2.0 or higher between the countershaft and the driveshaft for the torque conversion of the torque from the starter.

In an example embodiment, the starter is arranged outside of the engine housing. The starter can be flanged onto the engine housing. The starter, and particularly electrical components of the starter, can thereby be protected from contamination by motor oil. The starter preferably has a starter shaft which projects through the engine housing into the interior of the engine housing, and is coupled to the driveshaft inside the engine housing via the transmission shaft. The starter can be flanged onto the engine housing radially outside with respect to the starter shaft, such that the flange connection seals the starter shaft at the same time.

In an example embodiment, the starter is coupled to the transmission shaft via at least one freewheel and/or at least one clutch. This makes it possible to interrupt the flow of torque between the starter and the driveshaft, after the motor vehicle engine is started. A switchable freewheel and/or a switchable clutch is/are preferably included. In this way, the starter can be used for the various operating modes described above. The clutch can be designed, by way of example, as a friction clutch, particularly a disk clutch or multi-disk clutch, or as a positive-fitting clutch—for example, a jaw clutch.

The starter can be coupled to the driveshaft for the purpose of starting the motor vehicle engine, via a first gear with a first transmission ratio, and via a second gear, at a second transmission ratio which is different from the first transmission ratio, for the purpose of operating the starter in generator mode. This makes it possible to select the first transmission ratio for the starter mode, and by way of example the second transmission ratio for a generator mode or boost mode. When the torque flows via the first gear, the starter is coupled to the driveshaft via the transmission shaft. When the torque flows via the second gear, the starter can be coupled to the driveshaft via the transmission shaft, although it is also possible to divert the flow of torque around the transmission shaft used for starting the motor vehicle engine, in order to couple the starter to the driveshaft. The flow of torque via the first gear or via the second gear can be switched by means of at least one freewheel and/or at least one clutch. The clutch can be designed, by way of example, as a friction clutch, such as a disk clutch or multi-disk clutch, or as a positive-fitting clutch—for example a jaw clutch. It is possible to interrupt the flow of torque both via the first gear and also via the second gear, at the same time. It is preferred that the construction rules out a flow of torque via both gears at the same time. Due to the different gears, which are designed with gear tooth pairings with different gear diameters, it is simple to achieve different values for the first transmission ratio and the second transmission ratio. By way of example, a total transmission ratio of i_{ges, 1}=6.0 or i_{ges,} 1=4.0 can be achieved by means of the first gear for starting the motor vehicle engine, and a total transmission ratio of i_{ges, 2}=2.3 or i_{ges, 2}=2.5 can be achieved by means of the second gear for a generator mode.

In an example embodiment, an auxiliary assembly, such as an air conditioner compressor, can be coupled via a separator, such as a freewheel or clutch, to the driveshaft and/or to the transmission shaft, wherein the auxiliary assembly can be driven by the driveshaft when the separator is closed, and by the starter and/or an additional motor when the separator is open. This makes it possible to drive the auxiliary assembly via the driveshaft of the motor vehicle engine when the separator is closed. When the motor vehicle engine is switched off, the auxiliary assembly can be driven by the starter and/or the additional motor, particularly to enable air conditioning when the motor vehicle is parked. It is also possible to disengage the auxiliary assembly once the motor vehicle engine is started, such that it is possible to interrupt a flow of torque to the auxiliary assembly, by way of example if the auxiliary assembly should not be operated, such that reactive power losses are prevented.

The invention further relates to a method for starting a motor vehicle engine, such as an internal combustion engine, wherein a start torque is directed, inside of an engine housing of the motor vehicle engine, at a transmission ratio, into a driveshaft which projects out of the engine housing—which can be a crankshaft.

The method can be designed and implemented as described above in the context of the use and/or the motor vehicle engine. Because the start torque is directed into the driveshaft inside of the engine housing rather than outside of the engine housing, it is possible to use a transmission shaft which is already, by default, included inside the engine housing, for the purpose of directing a start torque into the driveshaft, such that it is possible to dispense with an additional gear. As a result, the configuration enables a cost-effective design with a construction which saves space for the purpose of starting the motor vehicle engine—particularly for start-stop applications.

### BRIEF DESCRIPTION OF THE DRAWINGS

The invention is described in greater detail below with reference to the attached drawings and using the example of preferred embodiments, wherein the features illustrated below can each constitute an aspect of the invention alone or in combination, wherein:

FIG. 1 is a schematic principle illustration of a starter connection for a motor vehicle engine in a first example embodiment;

FIG. 2 is a schematic principle illustration of a starter connection for a motor vehicle engine in a second example embodiment;

FIG. 3 is a schematic principle illustration of a starter connection for a motor vehicle engine in a third example embodiment;

FIG. 4 is a schematic principle illustration of a starter connection for a motor vehicle engine in a fourth example embodiment;

FIG. 5 is a schematic principle illustration of a starter connection for a motor vehicle engine in a fifth example embodiment;

FIG. 6 is a schematic principle illustration of a first variant of the starter connection for a motor vehicle engine in FIG. 4; and,

FIG. 7 is a schematic principle illustration of a second variant of the starter connection for a motor vehicle engine in FIG. 4.

### DETAILED DESCRIPTION

At the outset, it should be appreciated that like drawing numbers on different drawing views identify identical, or functionally similar, structural elements of the disclosure. It is to be understood that the disclosure as claimed is not limited to the disclosed aspects.

Furthermore, it is understood that this disclosure is not limited to the particular methodology, materials and modifications described and as such may, of course, vary. It is also understood that the terminology used herein is for the purpose of describing particular aspects only, and is not intended to limit the scope of the present disclosure.

Unless defined otherwise, all technical and scientific terms used herein have the same meaning as commonly understood to one of ordinary skill in the art to which this disclosure belongs. It should be understood that any methods, devices or materials similar or equivalent to those described herein can be used in the practice or testing of the disclosure.

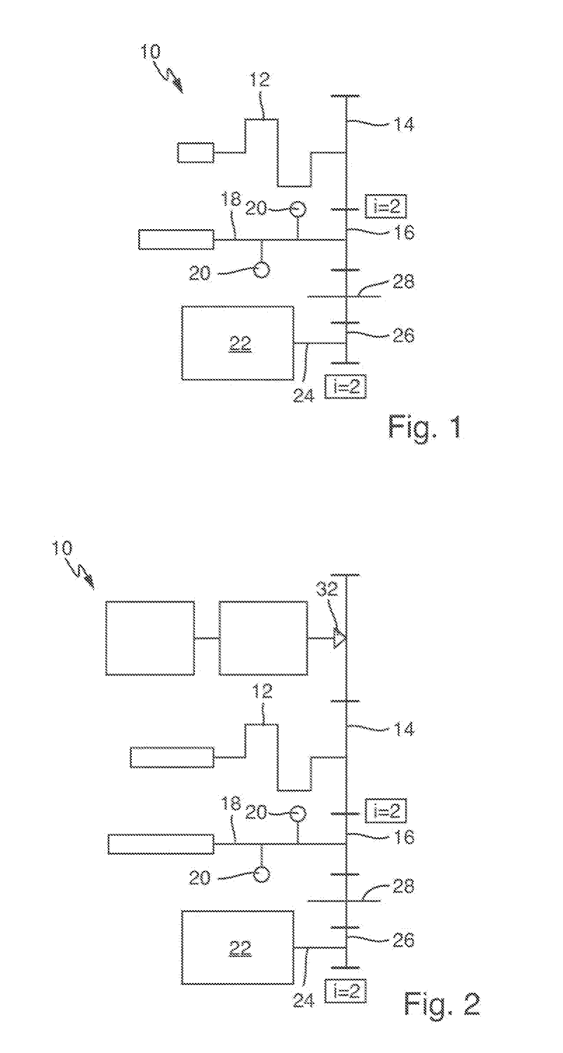

The highly schematically-illustrated starter connection 10 in FIG. 1 for a motor vehicle engine—the same not illustrated in detail to improve clarity—has driveshaft 12 designed as a crankshaft, which can be driven by pistons of combustion cylinders of the motor vehicle engine inside an engine housing of the motor vehicle engine. Driveshaft 12 can project out of the engine housing in order to drive a motor vehicle. For this purpose, driveshaft 12 can be coupled, by way of example, via a rotational vibration damper—for example a double-mass flywheel—and a starter coupling, to a motor vehicle transmission, which can relay the torque generated by the motor vehicle engine to drive wheels of the motor vehicle. Driveshaft 12 has driveshaft gear 14 which is coupled to a transmission shaft, the same designed as countershaft 18, via countershaft gear 16. A transmission ratio of i=2.0 is effected by the gearwheel pairing between driveshaft gear 14 and countershaft gear 16, such that countershaft 18 can dampen rotational vibrations of the 2nd engine order by means of deliberately configured imbalances 20. In addition, starter 22 is connected via countershaft gear 16. Starter 22 has starter shaft 24 with starter gear 26. Starter gear 26 meshes with intermediate shaft 28, wherein a transmission ratio of i=2.0 is effected between starter shaft 24 and intermediate shaft 28. Starter shaft 24 and starter 22 can particularly be positioned at a distance from driveshaft 12 as a result of intermediate shaft 28, such that starter 22 can be positioned in a region which provides sufficient constructed space for starter 22. Intermediate shaft 28 intermeshes with countershaft 18 with a transmission ratio of i=1.0, such that starter 22 is coupled to the driveshaft via countershaft 18, the same arranged entirely inside the engine housing, with a total transmission ratio of i_{ges}=4.0.

In the example embodiment of starter connection 10 illustrated in FIG. 1, there is a fixed translation between driveshaft 12 and starter 22. As a result, there is a particularly simple and space-saving construction of starter connection 10. Starter 22 is particularly constructed in such a manner that starter 22 can provide sufficient start torque for starting the motor vehicle engine, and does not exceed a maximum allowable rotation speed of starter shaft 24 after the motor vehicle engine is started. Such a starter arrangement 10 is particularly suitable for gasoline and/or diesel motors with low engine displacement, which require relatively low starting torque and are intended to have a particularly small construction.

In the example embodiment of starter arrangement 10 illustrated in FIG. 2, in contrast to the example embodiment of starter arrangement 10 illustrated in FIG. 1, an auxiliary assembly 30 is additionally coupled to driveshaft 12, for example an air conditioning compressor of an air conditioning system. The auxiliary assembly can particularly be coupled to driveshaft 12 directly or indirectly via separating element 32—for example, a freewheel. This enables the operation of the auxiliary assembly independent from the operation state of the motor vehicle engine, for example, when the motor vehicle engine is shut off and driveshaft 12 is stationary, and enables the supply of power required for this via starter 22 and/or auxiliary motor 34 coupled to auxiliary assembly 30, by way of example. As a result of separating element 32, the configuration avoids the need for driveshaft 12 and the components coupled to driveshaft 12 to be moved along with the same when auxiliary assembly 30 is operated and the motor vehicle engine is shut off. When the motor vehicle engine is started, separating element 32 can couple auxiliary assembly 30 to driveshaft 12 for the purpose of operating auxiliary assembly 30, with a transmission ratio of i=1.0 or a more suitable transmission ratio which varies from 1.0, such that it is possible to drive auxiliary assembly 30 by means of the torque provided by the motor vehicle engine. Auxiliary assembly 30 is preferably coupled via driveshaft gear 14—with which countershaft gear 16 also intermeshes.

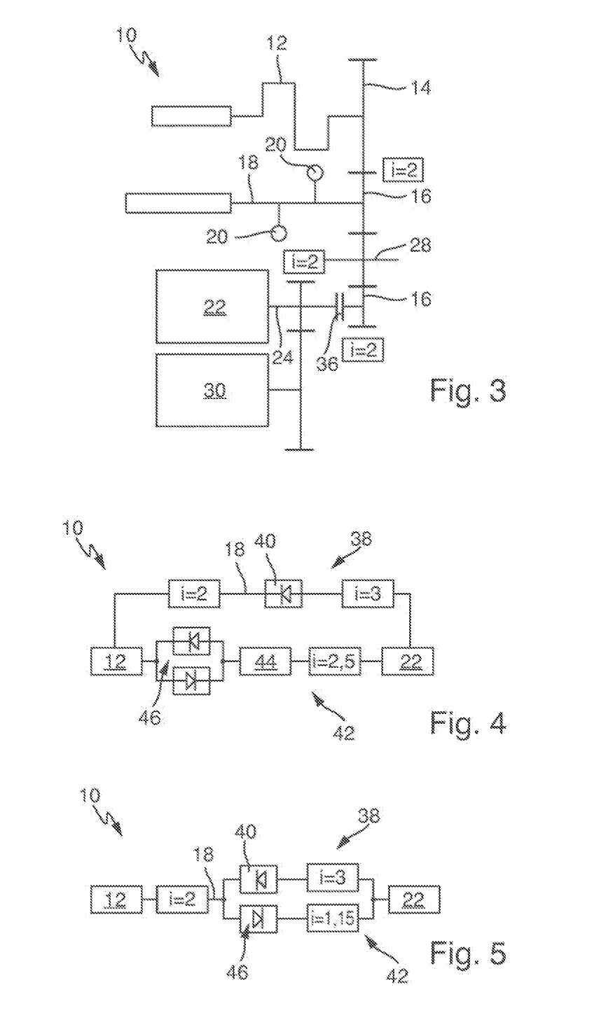

In the example embodiment of starter arrangement 10 illustrated in FIG. 3, in contrast to the example embodiment of the starter arrangement 10 illustrated in FIG. 2, auxiliary assembly 30 is not directly coupled to driveshaft 12; rather, it is first coupled to starter shaft 24. In addition, starter 22 can be coupled together with auxiliary assembly 30 coupled to starter shaft 24 by means of coupling 36 of driveshaft 12 and countershaft 18 and intermediate shaft 28, such that auxiliary assembly 30 can also be driven by starter 22, with no auxiliary motor 34, when the motor vehicle engine is shut off.

As is shown in starter arrangement 10 in FIG. 4, it is also possible to couple starter 22 to driveshaft 12 inside the engine housing with various different transmission ratios for the starter operation mode, on the one hand, and for the generator operation mode, by way of example, on the other hand, and no planetary gear is necessary for this purpose. The starter can be coupled via first gear transmission 38 in a manner comparable to that of the example embodiments of the starter arrangement shown in FIG. 1, FIG. 2, and FIG. 3. The flow of torque between starter 22 and driveshaft 12 proceeds via first gear transmission 38 when the motor vehicle engine is started, incorporating the transmission shaft designed, by way of example, as countershaft 18. In this case, by way of example, countershaft 18 can effect a transmission ratio of i=2.0, and the connection of starter 22 a transmission ratio of i=3.0, such that there is a total transmission of i_{ges}=6.0 when the flow of torque is routed via first gear transmission 38. This flow of torque can particularly be interrupted after the motor vehicle engine is started, by means of first coupling element 40 which is designed as a freewheel, by way of example.

First coupling element 40 can be designed comparably to the example embodiment of starter arrangement 10 illustrated in FIG. 3, for example as clutch 36 as well. When the flow of torque is interrupted via first gear transmission 38, starter 22 can be coupled to driveshaft 12 via second gear transmission 42, wherein in the example embodiment illustrated in FIG. 4, the flow of torque is routed from starter 22 to the driveshaft, bypassing countershaft 18. Second gear transmission 42 can have torque transmission means 44 for this purpose which is designed, by way of example, as a belt drive with a belt pulley which is able to couple to driveshaft 12. Torque transmission means 44 can be connected to driveshaft 12 via second coupling element 46, wherein second coupling element 46 in the illustrated example embodiment is designed as a switchable freewheel. However, it is also possible to design second coupling element 46 as a simple freewheel or clutch. When the torque flows via second gear transmission 42, particularly with a transmission ratio which is less in comparison to a flow of torque via first gear transmission 38, starter 22 can be coupled with a total transmission of i_{ges, 2}=2.5, by way of example, such that a maximum allowable rotation speed of starter shaft 24 is not exceeded when starter 22 is operated in generator mode.

In the example embodiment of starter arrangement 10 illustrated in FIG. 5, in contrast to the example embodiment of starter arrangement 10 illustrated in FIG. 4, starter 22 is coupled to driveshaft 12 via countershaft 18 when the flow of torque is routed via second gear transmission 42. Due to the additional transmission effected by countershaft 18, it is sufficient if second gear transmission 42 provides an accordingly small transmission ratio of, by way of example, i=1.15, in order to reach a total transmission ratio of i_{ges, 2}=2.3. In the example embodiment shown in FIG. 5, both first coupling element 40 and second coupling element 46 are designed as simple freewheels, such that a flow of torque occurs automatically, during starter operation mode, from starter 22 to driveshaft 12, without a separate, active actuator system, only via first gear transmission 38, and after the motor vehicle engine is started, a flow of torque occurs automatically from driveshaft 12 to starter 22, only via second gear transmission 42.

As illustrated in FIG. 6, gear transmissions 38, 42 of starter arrangement 10 illustrated in FIG. 5 can be implemented by first gear pairing 48 of starter shaft 24 with intermediate shaft 28 for first gear transmission 38, and by second gear pairing 50 of starter shaft 24 and intermediate shaft 28 for second gear transmission 42. Gear pairings 48, 50 can each be coupled via coupling element 40, 46 designed as a freewheel.

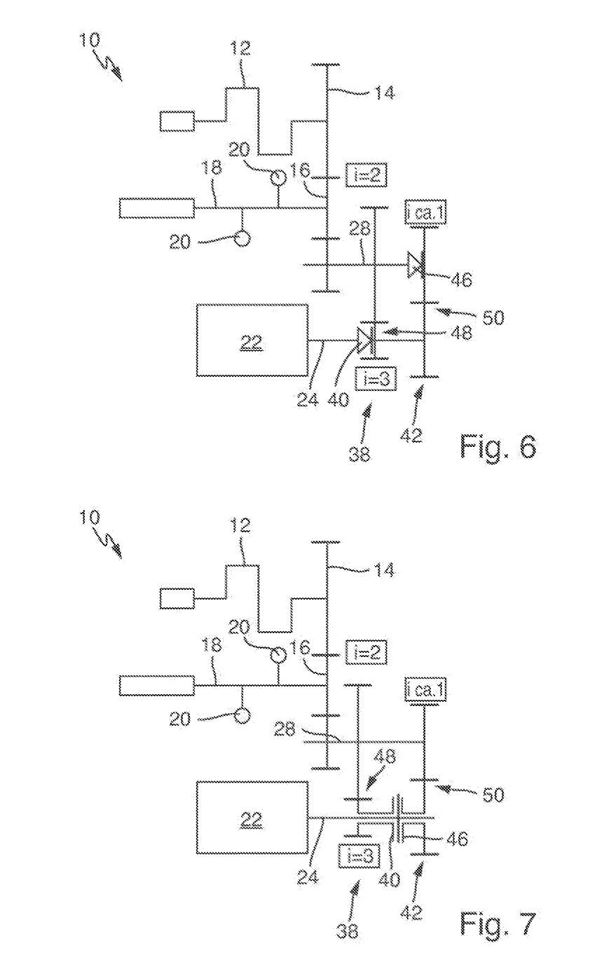

As is illustrated in FIG. 7, the freewheels of coupling elements 40, 46 used for starter arrangement 10 illustrated in FIG. 6 can be replaced by clutches, wherein it is possible to configure both of coupling elements 40, 46 designed as clutches only on starter shaft 24 or only on intermediate shaft 28. Coupling elements 40, 46 designed as clutches can be actuated by means of a sliding coupling in such a manner that, when one coupling element 40, 46 is closed, the other coupling element 46, 40 must necessarily be open. In particular, there can be an intermediate position in which both coupling elements 40, 46 are open.

It will be appreciated that various of the above-disclosed and other features and functions, or alternatives thereof, may be desirably combined into many other different systems or applications. Various presently unforeseen or unanticipated alternatives, modifications, variations, or improvements therein may be subsequently made by those skilled in the art which are also intended to be encompassed by the following claims.

### LIST OF REFERENCE NUMBERS

10 Starter connection
12 Driveshaft
14 Driveshaft gear
16 Countershaft gear
18 Countershaft
20 Imbalance
22 Starter
24 Starter shaft
26 Starter gear
28 Intermediate shaft
30 Auxiliary assembly
32 Separating element
34 Auxiliary motor
36 Coupling
38 First gear transmission
40 First coupling element
42 Second gear transmission
44 Torque transmission means
46 Second coupling element
48 First gear pairing
50 Second gear pairing

What is claimed is:

1-11. (canceled)

12. An engine for a motor vehicle, comprising:
an engine housing;
a driveshaft for controlling valves of combustion cylinders, the driveshaft is arranged to be driven from inside the engine housing;
a transmission shaft coupled to the driveshaft and operatively arranged to damp a rotational vibration of the driveshaft; and,
a starter coupled to the transmission shaft to direct a start torque into the driveshaft to start the motor vehicle engine.

13. The engine of claim 12, wherein the driveshaft is a crankshaft.

14. The engine of claim 12, wherein the transmission shaft is a countershaft.

15. The engine of claim 12, wherein the transmission shaft is permanently coupled to the driveshaft with a transmission ratio of i>1.0.

16. The engine of claim 12, wherein the transmission shaft is partially housed within the engine housing and projects out of the engine housing

17. The engine of claim 12, wherein the transmission shaft is arranged entirely inside the engine housing.

18. The engine of claim 12, wherein the starter is arranged externally to the engine housing, and attached to the engine housing by flanges.

19. The engine of claim 12, wherein the starter is coupled to the transmission shaft by at least one freewheel.

20. The engine of claim 12, wherein the starter is coupled to the transmission shaft by at least one clutch.

21. The engine of claim 12, further comprising:
a first gear transmission with a first transmission ratio operatively arranged to couple the starter to the driveshaft; and,
a second gear transmission with a second transmission ratio different from the first transmission ratio, the second gear transmission operatively arranged to couple the starter to the driveshaft and to operate the starter as a generator.

22. The engine of claim 12, further comprising an auxiliary assembly, coupled to the driveshaft and/or to the transmission shaft by a separating element, wherein the auxiliary assembly can be driven by the driveshaft when the separating element is closed, and by the starter and/or an auxiliary motor when the separating element is open.

23. The engine of claim 22, wherein the auxiliary assembly is an air conditioning compressor.

24. The engine of claim 22, wherein the separating element is a freewheel.

25. The engine of claim 22, wherein the separating element is a clutch.

26. A method for starting a motor vehicle engine, the method comprising the steps of:
directing a start torque inside an engine housing of the motor vehicle engine into a driveshaft; and,
guiding the driveshaft out of the engine housing.

27. A method for driving a motor vehicle having a motor vehicle engine, the method comprising the steps of:
providing a starting torque with a starter;
directing the starting torque into a driveshaft to start the motor vehicle engine;
controlling valves of internal combustion cylinders with the driveshaft; and,
damping rotational vibration of the driveshaft with a transmission shaft coupled to the driveshaft, the transmission shaft arranged inside an engine housing of the motor vehicle engine and projecting out of the engine housing.

28. The method of claim 27, wherein the transmission shaft is coupled to the driveshaft with a fixed and permanent transmission ratio of i>1.0.

29. The method of claim 27, wherein the starter is coupled to the transmission shaft by at least one freewheel.

30. The method of claim 27, wherein the starter is coupled to the transmission shaft by at least one clutch.
